(19) United States
(12) Patent Application Publication
(10) Pub. No.: US 2016/0260310 A1
(43) Pub. Date: Sep. 8, 2016

(54) REMOTE MONITORING SYSTEM

(71) Applicant: CADUCEUS INTELLIGENCE CORPORATION, Tucson, AZ (US)

(72) Inventor: Tzu-Wang Chuang, Tucson, AZ (US)

(21) Appl. No.: 14/675,217

(22) Filed: Mar. 31, 2015

Related U.S. Application Data
(60) Provisional application No. 62/127,648, filed on Mar. 3, 2015.

(51) Int. Cl. G08B 21/04

(52) U.S. Cl. CPC G08B 21/0446; G08B 21/0461

(57) ABSTRACT

This disclosure relates to a system and methods for monitoring a person or animal remotely. The monitored person may be an elderly person, disabled person, or other person who may experience some difficulty or risks in living alone, or an animal. The system and methods use sensors that may be worn by the person or animal or attached to objects in the person's or animal's location to monitor the status of the person or animal and the objects. In response to certain information detected by the sensors, the system or methods may provide for notifying other individuals, including the person's family, friends or emergency response personnel or caretaker, that the person or animal needs assistance.

### CROSS REFERENCE TO RELATED APPLICATION

This application claims priority from U.S. Provisional application Ser. No. 62/127,648, filed Mar. 3, 2015.

### FIELD OF DISCLOSURE

This disclosure relates to a system and methods for remote monitoring. The disclosure has particular utility for use in remotely monitoring a person who may have difficulty living alone, such as an elderly or disabled person, and providing notifications to the person's family or friends or emergency response personnel as necessary, and will be described in connection with such uses, although other utilities are contemplated.

### BACKGROUND OF THE DISCLOSURE

A large portion of the population is composed of elderly, or senior citizens who are suffering from one chronic condition or the other. Most of the senior citizens value their independence and require a non-intrusive support system that does not make them dependent on external help in cases of emergency. Also, a lot of children with elderly parents either live far away from their parents or are constantly absent from their parents' lives due to work commitments.

Statistics show that the number of senior citizens living alone has increased and so has the number of incidents, e.g., unexpected falls and complete dependence on caretakers even in cases of emergencies. Many accidents, complications and deaths occur as a result of delayed care received by these elderly persons. According to the U.S. census, 1 in every 3 adults sustains injuries due to a fall every year. Many fall multiple times, sometimes 5 times in a year leading to severe and many a times, fatal injuries.

Apart from the elderly, physically disabled people, mentally challenged people, and other people who may be at risk for accidents in the home may also experience similar challenges when living alone.

Accordingly, there exists a need heretofore unmet in the relevant field to address the needs of these people by providing a home health monitoring system and methods that combine the power of information technology with sensor monitoring to improve emergency care available to senior citizens that live with little or no assistance.

### SUMMARY OF THE DISCLOSURE

Embodiments of the present disclosure relate to a system and methods for remotely monitoring a person in the person's home. Briefly described, one embodiment of the system, among others, can be implemented as follows. The system may comprise at least one sensor configured to detect information related to a status of the person or an object in the person's home; a gateway configured to receive and transmit data based on the detected information from the at least one sensor; and a cloud computing system comprising a server for receiving and processing data from the gateway and algorithms for analyzing abnormal activity patterns, wherein the cloud computing system initiates an action based on the received data.

In another embodiment, the present disclosure provides a method of remotely monitoring a person in the person's home. Briefly described, one embodiment of the method, among others, can be implemented as follows. The method comprises the steps of detecting information related to the status of one or more of the person or at least one object in the person's home with at least one sensor located in the person's home; transmitting data based on the detected information to a gateway, wherein the gateway forwards the data to a cloud computing system; and receiving and processing the data from the gateway by a cloud computing system comprising a server, wherein the cloud computing system analyzes abnormal activity patterns and initiates an action based on the received data.

The features, functions, and advantages that have been discussed can be achieved independently in various embodiments of the present disclosure or may be combined in yet other embodiments, further details of which can be seen with reference to the following description and drawings.

Other features, functions and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTIONS OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a possible configuration of a service architecture for a monitoring system according to the present disclosure.

FIG. 2 shows a block diagram of an embodiment of an activity sensor according to the present disclosure.

FIG. 3 shows an exemplary embodiment of a key chain sensor according to the present disclosure.

FIG. 4 shows an exemplary embodiment of an attachable sensor according to the present disclosure.

FIG. 5 shows an exemplary embodiment of a wristband sensor according to the present disclosure.

FIG. 6 shows a block diagram of an exemplary embodiment of a home gateway according to the present disclosure.

FIG. 7 shows an exemplary embodiment of a home gateway according to the present disclosure.

FIG. 8 shows a flow diagram of an exemplary embodiment of data flow of a monitoring system according to the present disclosure.

FIG. 9 shows a block diagram of an exemplary embodiment of a user interface for a web portal of a monitoring system according to the present disclosure.

FIG. 10 shows an exemplary embodiment of input fields of a web port of a monitoring system according to the present disclosure.

FIG. 11 shows an exemplary embodiment of a sensor configuration screen of a web portal of a monitoring system according to the present disclosure.

FIG. 12 shows an exemplary embodiment of a dashboard screen of a web portal of a monitoring system according to the present disclosure.

FIG. 13 shows an exemplary embodiment of a notification settings screen of a web portal of a monitoring system according to the present disclosure.

FIG. 14 shows an exemplary embodiment of a privacy and sharing options screen of a web portal of a monitoring system according to the present disclosure.

FIG. 15 shows a flow diagram of an exemplary embodiment of an information and response generation system of a monitoring system according to the present disclosure.

FIG. 16 shows a diagram of a exemplary response time of a monitoring system according to the present disclosure.

FIG. 17 shows an exemplary embodiment of a postcard of a monitoring system according to the present disclosure.

### DETAILED DESCRIPTION

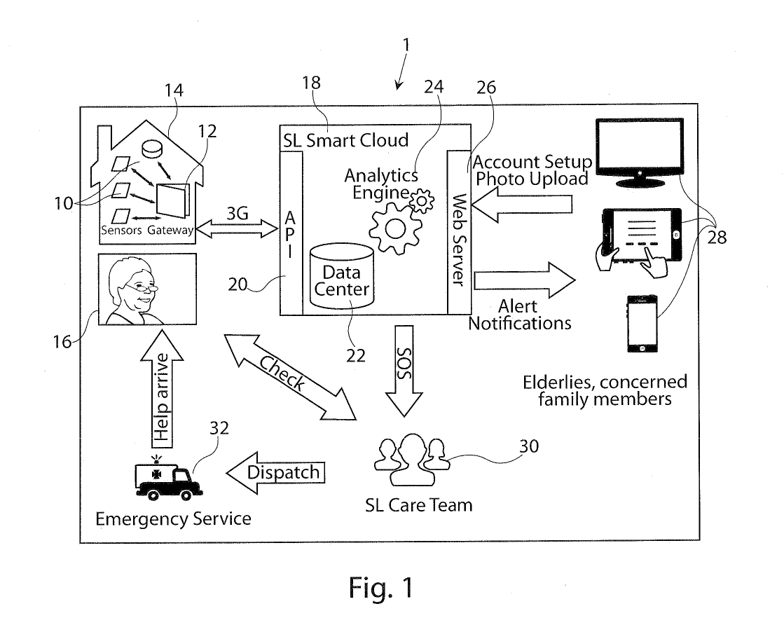

FIG. 1 depicts an exemplary embodiment of a possible service architecture for the remote monitoring system according to the present disclosure. Remote monitoring system 1 comprises at least one sensor 10. The sensors may be located in a residence 14 of a person or user 16 or in any other location where person or user 16 is present. The person or user 16 may be any person, including an elderly person, a physically handicapped person, a mentally challenged person, a child, or any other person who may experience some difficulty or risks in living alone. The person being monitored may also be referred to throughout this disclosure as the patient.

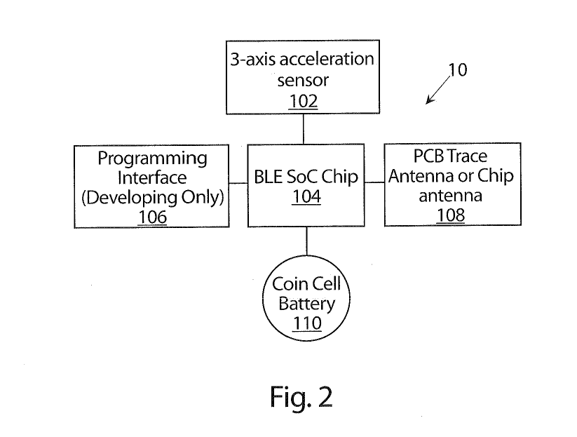

Referring to FIG. 2, it can be seen that sensor 10 may comprise an acceleration sensor, such as a 3-axis acceleration sensor 102. Sensor 10 may comprise an accelerometer. Sensor 10 may additionally or alternatively comprise other types of sensors, including force sensors, pressure sensors, temperature sensors, and the like that may be used to detect signals, data and other information related to the environment and position of the sensor. Sensor 10 may further comprise a wireless communication system, such as Bluetooth (e.g., BLE 4.0). The communication system may alternatively be any wired or wireless protocol that enables communication between devices, including local area networks (LAN), wide area networks (WAN), the Internet, Wireless LAN, Wi-Fi, mobile device networks, IEEE 802.11, GSM, GPRS, UMTS, 3G and 4G communications protocols, or any other network arrangement and/or protocol known to those having ordinary skill in the art. This permits sensor 10 to communicate with other devices, e.g., transmitting data detected by the sensor. In a preferred embodiment, sensor 10 comprises Bluetooth Low Energy system-on-chip (BLE SoC) 104. Sensor 10 may further comprise a printed circuit board (PCB) trace antenna or chip antenna 108 configured to amplify a communication signal or to enhance the sending or receiving of signals or data by the sensor. In a preferred embodiment, sensor 10 may also periodically emit signals that are indicative of its status such as a power or low-battery signal or a heartbeat signal that can be used to indicate normal operation or to synchronize the sensor with other components of the monitoring system.

Sensor 10 may further comprise a programming interface 106, which may include a set of routines, protocols and other tools related to the sensor and its communication protocol (e.g., BLE 4.0). The sensor may also comprise a power source, such as a coin cell battery 110. Exemplary specifications for the major components of sensor 10 are listed in Table 1.

TABLE 1
Major components of the activity sensors

| Item | Description | Note |
|---|---|---|
| BLE Controller | TI CC2541 | |
| 3-axis acceleration | MC3433 | 8 bit resolution, up to 128 |
| Sensor | | samples per second |
| BLE Antenna | PCB Trace Antenna | |
| | or chip antenna | |
| Coin Cell Battery | TBD | |

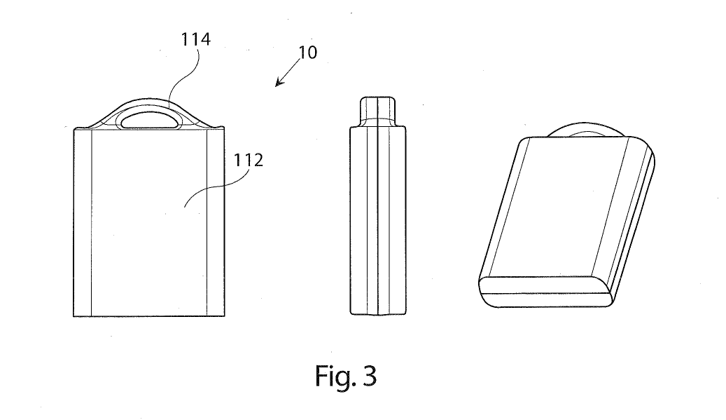

In a preferred embodiment, sensor 10 may include a hook or loop that allows the sensor to be attached to an object. As shown in FIG. 3, sensor 10 may include a casing 112. The casing may comprise plastic or metal or any other suitable material that ideally provides durability and is lightweight. Sensor 10 also may include a hook or loop 114 that allows the sensor to be attached to an object. For example, hook or loop 114 may allow sensor 10 to be attached to a keychain or belt loop such that a person can easily carry the sensor.

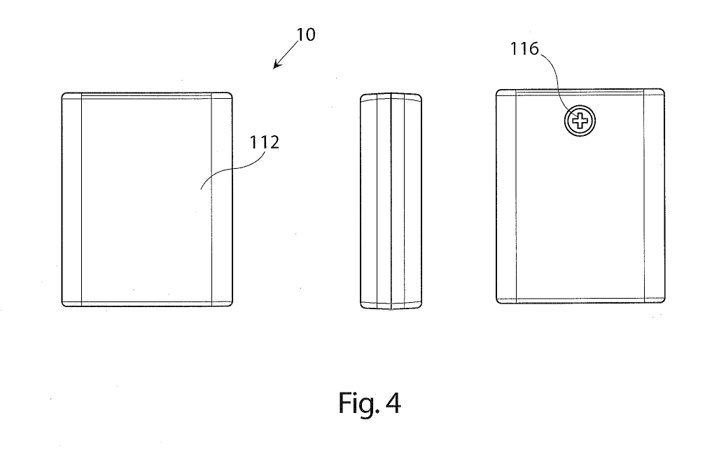

FIG. 4 shows another preferred embodiment of sensor 10, in which sensor 10 includes an attachment mechanism 116. The attachment mechanism allows the sensor to be attached to a variety of different objects, such as a door, furniture, appliance, etc. The attachment mechanism also may allow the sensor to be wearable. For example, it may be attached to a wristband or armband or pinned to a person's clothing. The attachment mechanism may comprise, for example, a screw, a hook, a clip, a nail, a brad, a clasp, a pin, a bracket, a strap or a strip of adhesive material such as tape or glue, or hook and loop fasteners. Sensor 10 may be of any size, although smaller sizes are typically preferred. In one exemplary embodiment, sensor 10 may be approximately 35.5×28×10 mm or 40.8×28×10 mm with a hook or loop 114. Sensor 10 may further include a label, e.g., for identifying an object to which the sensor is to be attached.

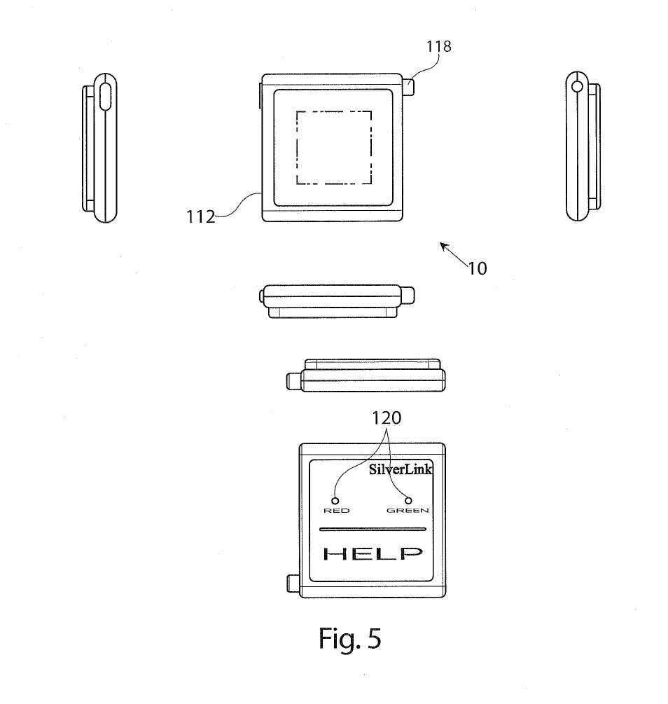

FIG. 5 shows another exemplary embodiment of a sensor 10. In this embodiment, sensor 10 may include an alarm button 118 that a user may press to send a distress or emergency signal. For example, if a patient falls or is injured, the patient may press button 118, thereby causing sensor 10 to transmit a wireless signal to other components in the remote monitoring system (e.g., a gateway, as discussed below). The patient may be required to press the button only once, or may be required to press and hold the button for a period of time to activate the signal. The monitoring system will then notify authorities, including police, firefighters, EMTs and/or paramedics that the patient needs assistance. The patient's family, friends and/or neighbors also may be notified when the patient sends the distress or emergency signal. Alarm button 118 preferably will have a size and shape that make it easy to locate and push, even when a patient is injured. The sensor may alternatively include a switch, toggle, or other actuator for initiating a distress or emergency signal. Sensor 10 may also comprise LED lights 120 to display the status of the sensor. For example, LED lights 120 may comprise a green light and a red light. The lights might function, for example, as follows: both lights are off when no event has occurred (e.g., button 118 has not been pressed); when the button is pressed, the red light flashes periodically (e.g., every 0.2 seconds); once a distress signal has successfully been sent and/or received, the green light will illuminate and stay on. If the signal is not successfully sent and/or received, the red light may continue to flash to alert the patient that the signal has not yet been successfully sent and/or received. Sensor 10 may further comprise a mechanism for resetting the sensor, including the LED lights, after a distress signal has been answered or otherwise resolved.

Referring back to FIG. 1, the remote monitoring system 1 further includes a (home) gateway 12. The home gateway 12 will typically be located in or near the residence 14 of a patient or user 16. The gateway 12 preferably is configured to receive signals, information, and data transmitted from one or more sensors 10. This information typically will include or be related to information detected by the sensor 10. Gateway 12 also is preferably configured to transmit such information to other components in the remote monitoring system 1, as is more fully discussed below.

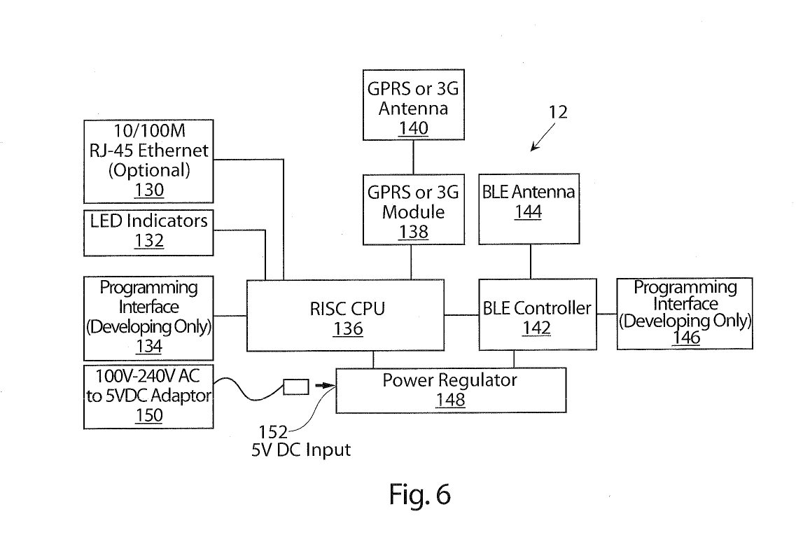

Referring to FIG. 6, a block diagram of an exemplary embodiment of home gateway 12 is shown. Gateway 12 comprises a CPU, e.g., a reduced instruction set computing (RISC) CPU 136. The CPU is primarily responsible for maintaining an internet connection and maintaining communication with other devices in the remote monitoring system. For example, the CPU may be responsible for gathering information from one or more sensors 10. An internet connection and communication with other devices may be accomplished with one or more wired or wireless communication protocols known in the art, including Bluetooth, local area networks (LAN), wide area networks (WAN), the Internet, Wireless LAN, Wi-Fi, mobile device networks, IEEE 802.11, GSM, GPRS, UMTS, 3G and 4G communications protocols, broadband connection, cable, DSL or satellite modem, ISDN, dial-up connection, or any other arrangement and/or protocol known to those having ordinary skill in the art. In a preferred embodiment, gateway 12 comprises a GPRS or 3G module 138 and a GPRS or 3G antenna 140 for maintaining a wireless internet connection. A 10/100M RJ-45 Ethernet port 130 for maintaining a wired internet connection also may be provided. Gateway 12 also preferably may include a BLE controller 142 and BLE antenna 144 for communication with other devices in the system, including sensors 10. Programming interfaces 134 and 146, in communication with the CPU and BLE controller, respectively, also may be included. Gateway 12 may also include LED indicators 132, or other status indicators, which may, for example, provide information on the power to the unit, internet connectivity, and/or connectivity with sensors and other devices. The gateway 12 also includes a power source, and preferably may include a power regulator 148, as well as a 100V-240V AC to 5V DC adapter 150 and 5V DC input 152. Alternatively, gateway 12 may be battery powered.

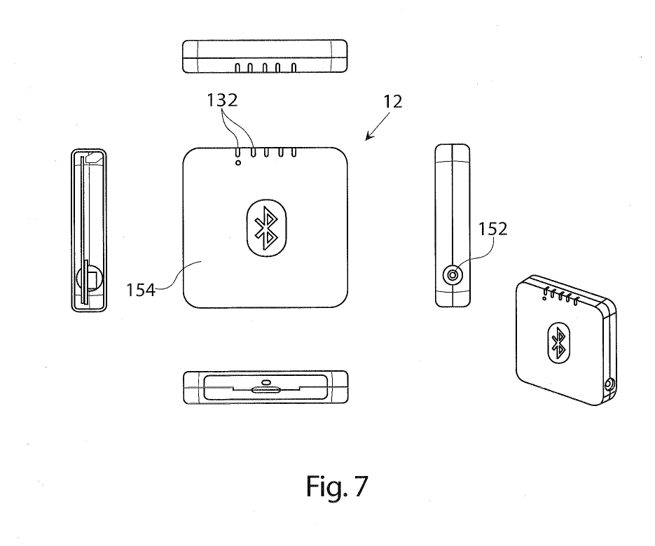

The gateway 12 may have any size and shape. A compact size, such as 100×100×200 mm is preferable. In a preferred embodiment, as shown in FIG. 7, gateway 12 will include a housing 154, which preferably may be plastic or metal or any other suitable material known in the art. An exemplary list of components of the gateway 12 is provided in Table 2.

TABLE 2
Major components of the Home Gateway

| Item | Description | Note |
|---|---|---|
| ARM CPU | ST 32F405 or compatible | ARM Cortex-M4 |
| | | 32 bits CPU core |
| BLE Controller | TI CC2541 | |
| BLE Antenna | PCB Trace Antenna | |
| GPRS or 3G Module | TBD | |
| GPRS/3G Antenna | PCB Trace Antenna | |
| RJ-45 Ethernet | 10/100M RJ-45 Ethernet | Optional |
| Power adaptor | Stand alone external 5 V | |
| | DC power adaptor | |

Referring back to FIG. 1, remote home monitoring system 1 may further include a cloud computing system 18. The cloud computing system 18 is in communication with the gateway 12, typically via an internet connection. Cloud computing system 18 may comprise a data collection API 20, a database or datacenter 22, an analytics engine 24, and a web portal or web server 26. In a preferred embodiment, the architecture of cloud computing system 18 and its various components includes software components as well as hardware components (servers, operating computers, etc.). The various components of the cloud computing system 18 may be linked through a communications network thereby allowing the various components to be located either near or remote from each other in certain instances.

In an exemplary embodiment, the data collection API 20 may include the following: transmission protocol: HTTP; authentication: HTTP basic authentication. Further, parameters may be submitted in a query string or in a POST body as JSON (JavaScript Object Notation) (content-type: application/json). An exemplary data collection API is shown in Table 3.

TABLE 3
This table shows data collection API

| HTTP | | Parameters/ | | |
|---|---|---|---|---|
| Method | URL | Request Body | Response | Note |
| GET | /sensors | gateway_id | {[(“id”: | Retrieve a list of the |
| | or | | “S1-1234”,), | sensors IDs of the |
| | /gateway/:id/sensors | | {“id”: | gateway |
| | | | “S2-1234”}]) | |
| POST | /gateway/status | gateway_id | | Send gateway |
| | or | event | | status |
| | /gateway/:id/status | | | event |
| | | | | Bit 0: heartbeat |
| POST | /sensor status | gateway_id | | Send sensor status |
| | or | sensor_id | | Event: |
| | /gateway/:id/sensor/:id/ | event | | Bit 0: heartbeat |
| | status | acc_x | | Bit 1: movement |
| | | acc_y, | | Bit 2: battery low |
| | | acc_z | | |
| POST | /sos | ateway_id | | Send SOS |
| | or | sensor_id | | |
| | /gateway/:id/sensor/:id/sos | | | |
| HEAD/GET | /time | | | Check server time |
| | | | | in HTTP header |

Datacenter 22 preferably is configured to store raw data collected from activity sensors 10 and sent to the datacenter 22 via gateway 12, typically via 3G service or a similar communication protocol. In a preferred embodiment, datacenter 22 is primarily software-based and run on one or more servers or in a similar computing environment. Datacenter 22 may further comprise a variety of tables for storing such raw data collected by the sensors and other components of the monitoring system. Examples of the types of data stored in the tables includes, but is not limited to, gateway, sensor and system information, gateway information, sensor information, system health, raw sensor log data, sanitized data for analysis, processed data representing user activities, and web portal management including such data as user login, user profile, links, notifications, and notification settings. Examples of database schema related to sensor tables, activity logs and SOS log tables are shown in Tables 4-6.

TABLE 4
Database schema sample: Sensor tables

| Column | Data Type | Example | Description |
|---|---|---|---|
| Sensor ID | Varchar | | Sensor serial number |
| Sensor Type | Varchar | S1, S2, S3, S4, | KS(keychain sensor), WS |
| | | KS, WS | (wristband sensor) |
| Activation | Varchar | E3A837DK | |
| Code | | | |
| Application | Varchar | Pillbox/ | |
| | | Refrigerator | |
| Location | Varchar | Living room | Optional |
| Heartbeat | Timestamp | | Last heartbeat received |
| Battery Low | Timestamp | | Last battery low event |
| | | | received |
| Battery | Timestamp | | Last time battery was |
| Replaced | | | replaced |

TABLE 5
Database schema sample: Activity Logs

| Column | Data Type | Example | Description |
|---|---|---|---|
| Gateway ID | Varchar | HTI295A9072Q | Gateway serial number |
| Sensor ID | Varchar | EEA6A873A37D | Sensor serial namber |
| Sensor Type | Char(2 ) | KS/WS/S1/S2/S3/S4 | Sensor Type |
| Acc X | Float | | Accelerometer x-axis |
| | | | reading |
| Acc Y | Float | | Accelerometer y-axis |
| | | | reading |
| Acc Z | Float | | Accelerometer z-axis |
| | | | reading |
| Timestamp | Integer | 1390156953 | Unix Time, which can |
| | | | be converted to UTC |

TABLE 6
Database schema sample: SOS log table

| Column | Data Type | Example | Description |
|---|---|---|---|
| Gateway ID | Varchar | HTI2K5A9072Q | Gateway serial number |
| SOS Sensor ID | Varchar | EEA6A873A37D | SOS alarm serial number |
| Sent at | Timestamp | | SOS alarm sent time |

Analytics engine 24 of cloud computing system 18 preferably is configured to process and analyze data obtained by other components of the system. Accordingly, analytics engine 24 may employ an algorithm (e.g., an abnormal pattern detection algorithm) to perform such tasks as advanced pattern recognition. Analytics engine 24 also may be configured to perform data transformation and integration, including filtering data for each individual user, noise reduction of various signals and data transmitted through the monitoring system, and building sanitized data tables for each individual user and his or her associated activities. The analytics strategy and approaches used by analytics engine 24 preferably may include defining activity signal patterns. For example, data obtained by a sensor on a door or a lid may be used to define signal patterns related to when the monitored door or lid is opened or closed. Similarly, signal patterns may be defined and analyzed with respect to movement of a piece of furniture (e.g., a sensor attached to a chair) or with respect to a person falling or suddenly stopping (e.g., a sensor worn or attached to the person). The analytics engine also may define patterns related to whether a particular sensor (whether attached to a person or an object) is in or out of range. Thus, based on signal patterns associated with the activity sensors, the analytics engine may then determine whether a signal reflecting a particular event or action has been detected, thereby indicating or predicting that the particular event or action has occurred (e.g., a door has opened; a chair has moved a certain distance; a person has fallen down; or a person has moved out of range). Detection of a particular signal may also be accomplished by determining whether a particular value or threshold value in the data has been met or exceeded. These various signals may then be recorded and stored in user activity tables or used by the system to, for example, send out notifications, as discussed below.

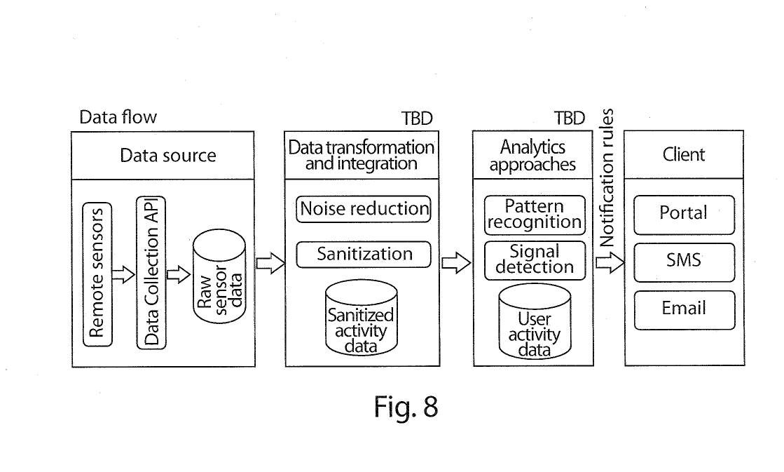

FIG. 8 depicts an exemplary embodiment of data flow through the monitoring system, including through the analytics engine 24. Briefly, data is sourced from the remote sensors, as described above, transmitted through the monitoring system to the data collection API such that a set of raw sensor data is generated. Data transformation and integration steps may then be performed on the raw data, including noise reduction and sanitization steps, to obtain sanitized activity data. Various analytics approached may then be performed on the data, including pattern recognition and signal detection, to generate user activity data. Next, notifications based on the data may then be sent out (e.g., via web portal, text message, phone call, or email) to various individuals and/or authorities, as is discussed more fully below.

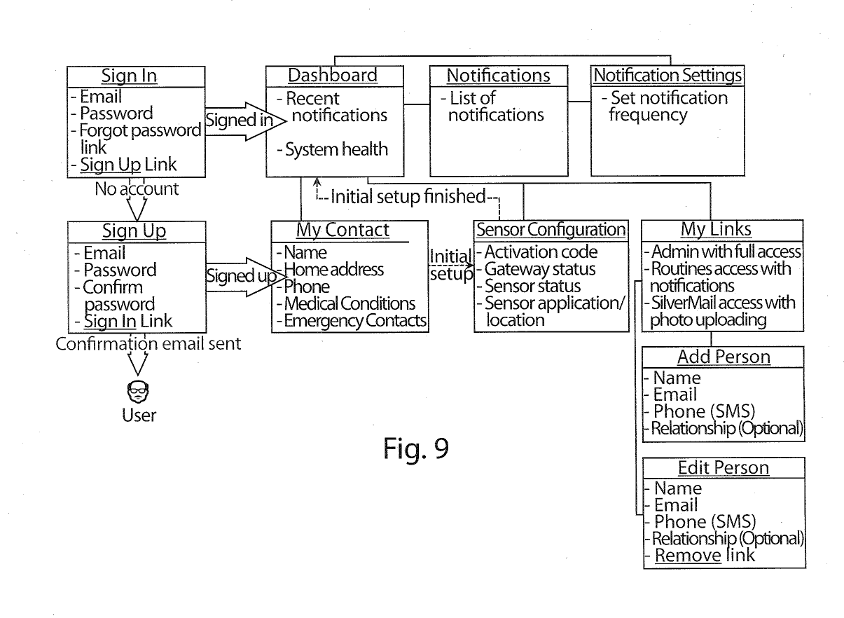

Web portal or web server 26 preferably comprises a series of screens that may, e.g., display information about the monitoring system or allow patients or other users to alter settings related to the monitoring system. As shown in FIG. 9, an exemplary user interface for web portal 26 may include screens or utilities related to patient or user sign in or registration (sign up); a dashboard; patient or user contact information; sensor configuration; notifications; notification settings; relevant links (“my links”); as well as administrative options such as adding or editing a new user profile. Web portal 26 may be accessible from, or transmit information to, any computing device 28, including a personal computer, tablet or smartphone.

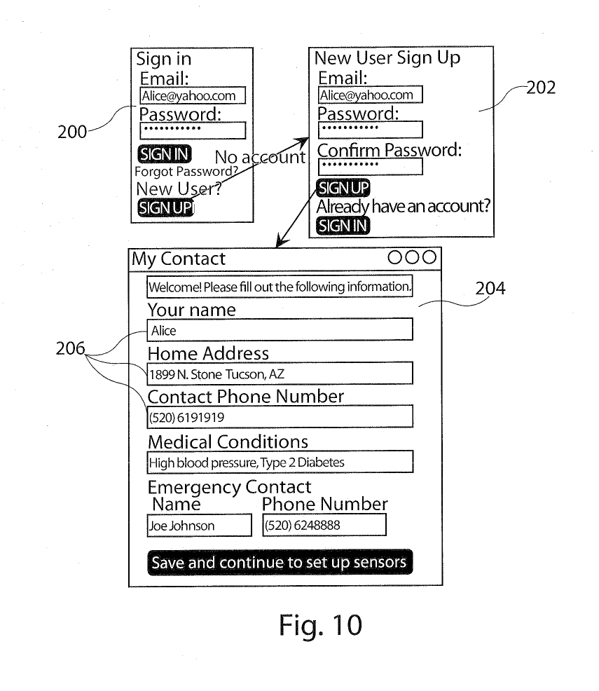

In a preferred embodiment, web portal 26 provides secure, password-protected access to specific registered users. Accordingly, users will typically be required to log in with specific information, such as an email address and a password. FIG. 10 shows an exemplary embodiment of a sign in screen 200, sign up screen 202, and contact information screen 204, including input fields 206 for entering requested information. When initially signing up for access to the web portal, certain information may be required. For example, a new user may be required to provide an email address and password, as well as contact information, including name, mailing address, phone number, and additional information, including medical conditions and emergency contact information. A new user may be a person whose activities will be monitored by the system (patient), or may be a family member, friend, or caretaker of that person. Web portal 26 may be configured to provide access to multiple users.

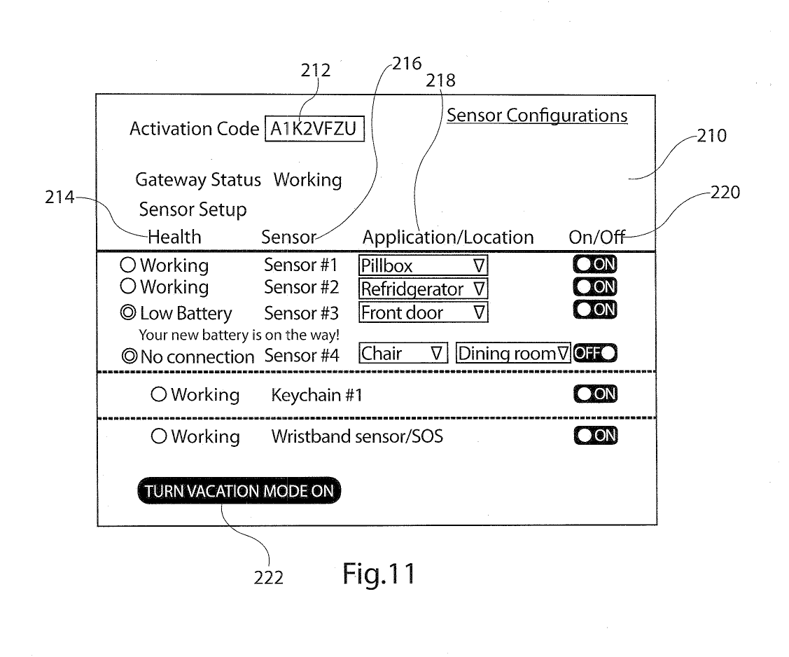

FIG. 11 shows an exemplary embodiment of a sensor configuration screen 210 of web portal 26. Sensor configuration screen 210 may include various information about the sensors used in the system, including a “health” field 214, which may give a general status of a sensor such as, for example, “working,” “low battery,” or “no connection”; a sensor identification field 216, which may provide an identification name or number for each sensor in the system (e.g., a one digit code); and a sensor application/location field 218, which permits a user to select the appropriate application or location of each sensor in the system. One or more drop-down menus may be used for each sensor in the sensor application/location field 218 to select options including any of the following: pillbox, medicine cabinet, refrigerator door, exterior door, interior door, shower door, main slipper, microwave door, oven door, trashcan lid, light switch (including options for, e.g., living room, dining room, bedroom, bathroom), or chair (including options for, e.g., living room, dining room, study), or other furniture or objects. A sensor on/off selector field, which permits a user to turn an individual sensor on or off, also may be included. The sensor configuration screen 210 may further include an activation code field 212, which can be used to activate a new sensor and synchronize it with the other components of the system. Finally, a vacation mode button 222 may be included. This button might, for example, permit a user to temporarily turn off all sensors or otherwise suspend activity of the system for a period of time (e.g., while the person being monitored is away on vacation). The fields on the sensor configuration screen 210 may be auto-populated or may be set by a user. The sensors may also be pre-configured to an assigned gateway 12 such that they cannot be used with a different gateway.

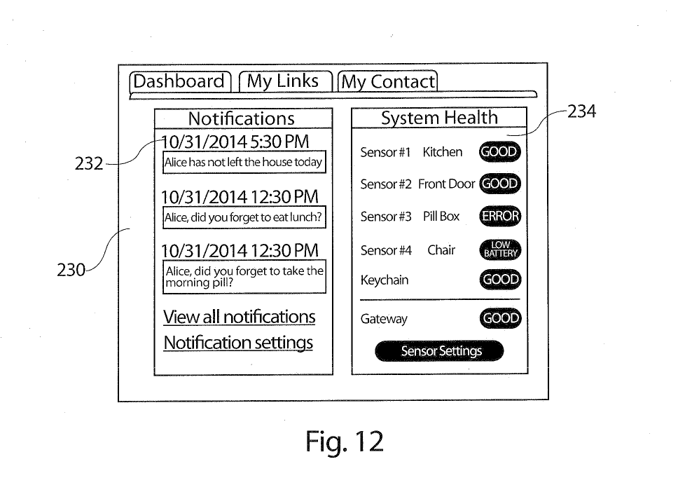

FIG. 12 shows an exemplary embodiment of a dashboard screen 230 of web portal 26. The dashboard screen may include a notifications box 232, which is configured to display notifications based on data obtained from the sensors. Notifications may include, for example, “Alice has not left the house today,” “Alice, did you eat lunch?” or “Alice, did you forget to take the morning pill?” Notification box 232 may also include an option for viewing all available notifications, including past notifications, as well as an option for viewing and changing notification settings. Dashboard screen 230 may also include a system health box 234 that displays a status of the sensors, gateway and other components in the monitoring system. A status may be displayed, for example, as “good,” “error,” “not in use (disabled),” “good battery” or “low battery.”

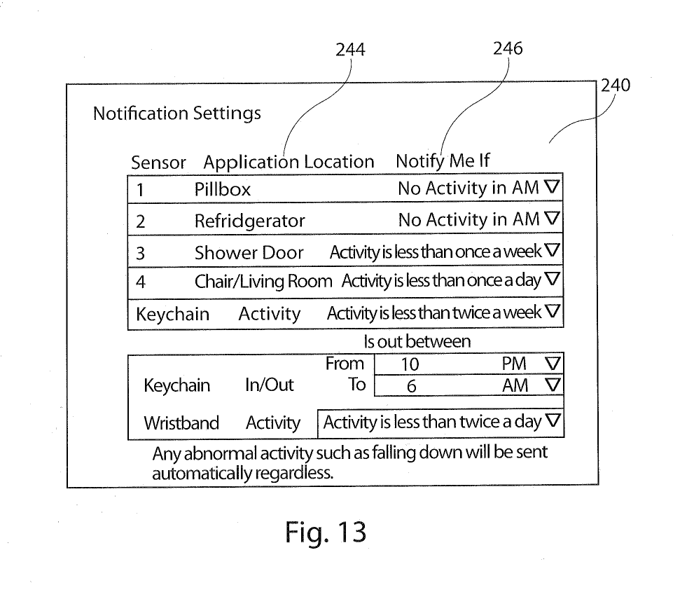

FIG. 13 shows an exemplary embodiment of a notification settings screen 240. Notification settings screen 240 may include, for example, a sensor identification field 242 and a sensor application/location field 244. Notification settings screen 240 also may include a notification selection field 246 where a user may select when or how often the system will send a notification in response to certain data detected (or not detected) by the sensor. For example, a user may select to be notified if a particular sensor senses little or no activity during a particular time of day (e.g., “No activity in AM”) or senses activity only less than a specified number of times per day, week, month, etc. A user also may choose to be notified if a sensor is taken out of range during a particular period of time (e.g., from 10 PM to 6 AM). Such notifications may be sent out by the system via one or more of email, text message, or phone call. A phone call may be an automated message or may be generated by a worker in a call center. Furthermore, the notification may be sent to one or more individuals, including the person being monitored, that person's family member, friend, or caretaker, or local authorities including police, fire, and rescue personnel.

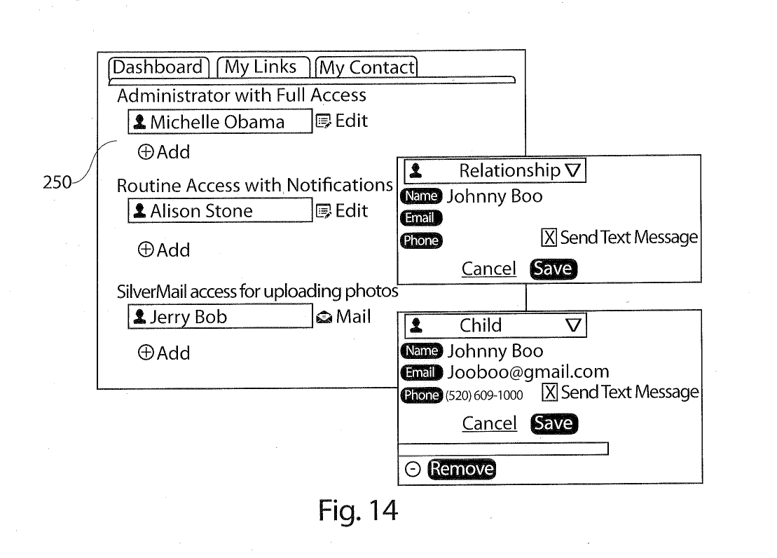

FIG. 14 depicts an exemplary embodiment of a privacy and sharing screen 250 of web portal 26. The privacy and sharing screen 250 allows a user to configure and determine which persons will received shared information from the system (e.g., notification alerts). Accordingly, the privacy and sharing screen 250 will allow a user to enter information such as a person's name, email, phone number, and other contact or identifying information. The user may also set a specific access level for each added person. Levels of access may vary from full access (e.g., administrator privileges) to limited access. A user may also select to remove a person from the screen to prevent the person from receiving shared information.

In various embodiments, the screens of web portal 26 may be combined or linked to each other in a variety of ways, as is known in the art. The various elements and fields of each screen may be included on different screens than as described above, or on more than one screen. Furthermore, in a preferred embodiment the information and access provided by the web portal may also be accessible via a mobile application accessible via any internet connected device, such as a mobile phone or tablet.

Referring again to FIG. 1, the monitoring system 1 may further include a care team 30. The care team 30 includes individuals that may receive notifications and other signals from the system. Based on the received notifications and signals, a member of the care team may notify the monitored person, or that person's family member, friend, or caretaker, so that the monitored person may receive any required assistance. The care team 30 also may, or alternatively, notify emergency service 32, including police, fire and rescue personnel, in response to received notifications and signals.

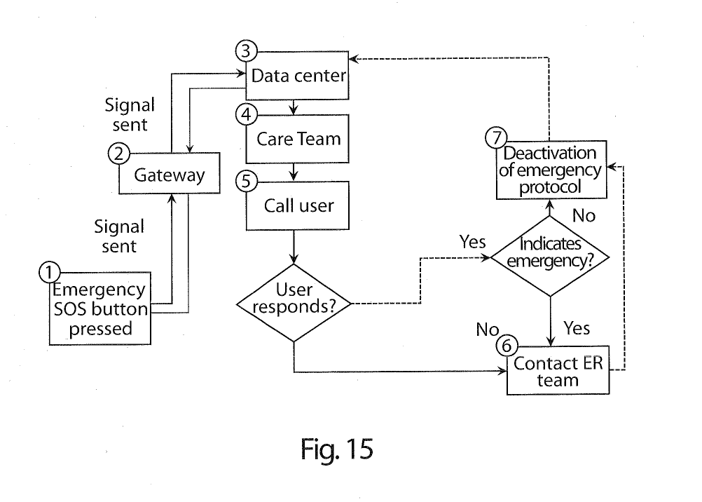

FIG. 15 depicts an exemplary embodiment of a process of notifying authorities when an emergency alarm button 118 (as shown in FIG. 5) is pressed. First, a patient presses the alarm button to activate a distress signal. The signal is transmitted to gateway 12, which then forwards the signal to datacenter 22. Datacenter 22 then forwards the signal, along with relevant patient information that is stored in the datacenter, to a care team 30. The care team 30 will then attempt to contact the patient (e.g., via phone) to rule out the possibility of a false alarm, thereby potentially eliminating any unnecessary costs associated with sending out emergency units and/or anxiety on the part of the patient's family members. If care team 30 determines that there is an emergency (e.g., because the patient failed to answer the phone or answered and confirmed the emergency), care team 30 will notify emergency services 32 to assist the patient. Alternatively, care team 30 may deactivate the emergency protocol if it determines that no emergency exists.

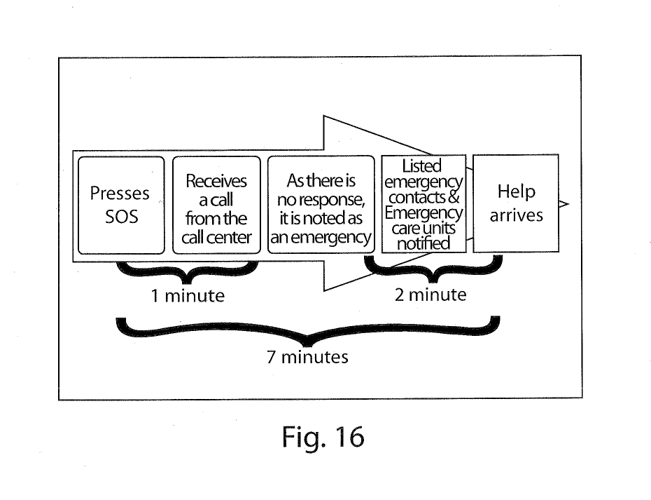

Quick response times are an important aspect of the system because of the need to address and resolve emergency situations. In one exemplary embodiment, as shown in FIG. 16, the remote monitoring system can initiate a response to an emergency in less than seven minutes from the time that the alarm button 118 is pressed. Response times may be decreased or improved by, for example, increasing the number of care teams, such that a backup may exist if necessary. Furthermore, every time a new patient or user enrolls, the system may update a list of emergency care facilities along with other patient information.

An exemplary embodiment of providing a quick response to an emergency via the remote monitoring system disclosed herein may be as follows. Once the call center has received the signal (e.g., indicating that a patient has fallen down, has pressed an alarm button, or is otherwise in need of assistance), it should initiate a phone call to the patient within 15 seconds of the signal received. If the patient does not answer, within the next minute, the call center should initiate calls to the emergency contacts as well as the nearest healthcare facility based on the location of the user (patient). If the first emergency contact does not respond, the next two should be contacted. Care should be provided to patients within ten minutes including all procedures listed above. In a second scenario, if the patient answers and informs that he/she needs assistive care, the call center personnel should immediately notify the emergency contacts but not the emergency care unit. In case of further assistance needed, the emergency contact can either call 911 or provide the assistance if not much is needed. To further assist with quick response times, it may be necessary to provide the care team with up-to-date patient information, including, e.g., age, gender, medical history, email address, phone numbers, pager numbers, closest neighbors (sorted by proximity, if necessary), preferred medical facilities and physicians, closest medical facilities to patient's home, medical insurance information, and any other relevant information.

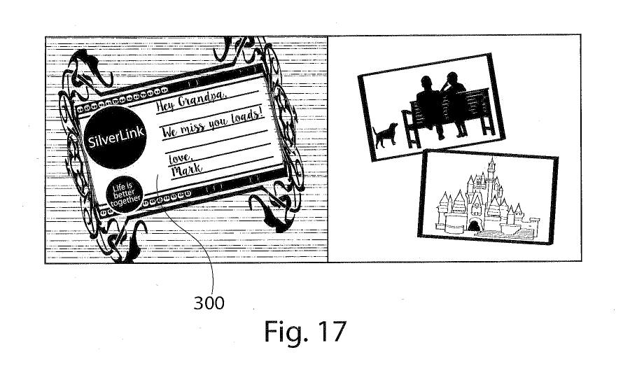

FIG. 17 depicts an optional additional feature of the remote monitoring system 1. In a preferred embodiment, the system may provide an additional service that will allow users to connect with their family members in a more personalized manner by sending monthly postcards 300 with family pictures, health charts, progress reports, personalized messages, and the like. The family members will also have an option to use the web portal 26 to record and upload video messages for their elderly relatives. The goal of this additional feature is to both motivate the elderly to keep using the tracking features of the system and better manage their health, as well as to help bridge the gap between the patient and his or her loved ones.

In a preferred embodiment, postcard 300 may include a summary of the patient's progress, showing charts and graphs of health determinants uploaded via the tablet along with motivational quotes from family members. These quotes can be words of encouragement or just praise for how well they are doing. In another preferred embodiment, a point system may be used based on the number of times the system is used in a given time period. For example, points may be allocated based on the number of trackings per month. After a patient has accumulated a certain number of points, he or she may be eligible for a gift, including gift cards and personalized gifts that may be sent to the patient or the patient's family and friends. In another embodiment, the system may provide a video message from the family for the patient. This can be done directly via the web portal 26, where the family members can record and save video messages for the patient. The messages may only be viewable by the patient, and the patient may receive a notification when a new message is available to view.

The remote monitoring system 1 may be available in kits, wherein a kit comprises various components required for a new patient or user to set up and use the system. In one embodiment, a kit may include one or more of a gateway with a power adapter, one or more sensors (including one or more keychain sensors, wearable sensors, sensors with alarm button, general sensors), welcome kit and user manual, activation code, and additional accessories (e.g., adhesives for attaching sensors to objects, stickers for labeling sensors). The activation code may be a unique, random code that may be preprogrammed into a gateway and sensors. A mapping table between a device serial code and activation code may be maintained in the cloud computing system (e.g., the datacenter). Each activation code may be tied to an individual user such that no other users will be allowed to use or associate the code. Preferable, only one activation code may be used with each gateway at a time; when a gateway is replaced, the new gateway may be preprogrammed with the user's existing activation code.

It should be emphasized that the above-described embodiments of the present disclosure, particularly, any “preferred” embodiments, are merely possible examples of implementations, merely set forth for a clear understanding of the principles of the disclosure. Many other variations and modifications may be made to the above-described embodiments of the disclosure without departing substantially from the spirit and principles of the disclosure. For example, the system may be incorporated into a care facility such as a hospital or assisted living facility, to provide care providers with early warning of a situation, e.g., a fall, of a person in their charge. The system also may be used to monitor prize livestock or the like. All such modifications and variations are intended to be included herein within the scope of the present disclosure and protected by the following claims.

1. A remote monitoring system for monitoring a person or animal in a location comprising:
at least one sensor configured to detect information related to a status of the person or animal and an object in the person's or animal's location;
a gateway configured to receive and transmit data based on the detected information from the at least one sensor; and
a cloud computing system comprising a server for receiving and processing data from the gateway and algorithms for analyzing a plurality of abnormal activities relative to a plurality of activity patterns, wherein at least one of the plurality of activity patterns further comprises an activity signal pattern of the object during a voluntary interaction of the person or animal with the object, wherein the cloud computing system initiates an action based on the received data.

2. The remote monitoring system of claim 1, wherein the at least one sensor further comprises an accelerometer located on the object in a person's or animal's location, wherein the object further comprises at least one of a pillbox, medicine cabinet, refrigerator door, exterior door, interior door, shower door, main slipper, microwave door, oven door, trashcan lid, light switch and furniture.

3. The remote monitoring system of claim 1, wherein the sensor is configured to detect if the person or animal has fallen, and/or is configured to send a user-activated distress signal.

4. The remote monitoring system of claim 1, wherein data is transmitted between the at least one sensor and the gateway wirelessly.

5. The remote monitoring system of claim 1, wherein the cloud computing system comprises one or more of a datacenter, an analytics engine, and a web server.

6. The remote monitoring system of claim 1, wherein the action initiated by the cloud computing system is to monitor information related to the status of the person or animal or an object in the person's or animal's location detected by the at least one sensor, and to transmit a notification related to the status of the person or animal or an object in the person's or animal's location to a family member, friend, neighbor or caretaker of the person or animal, or to police, fire or emergency response personnel.

7. The remote monitoring system of claim 1, wherein the cloud computing system further comprises a web portal hosted on a server, wherein the web portal is configured to provide access to one or more users to monitor or alter settings related to one or more components of the remote monitoring system.

8. The remote monitoring system of claim 7, wherein the access is secured.

9. The remote monitoring system of claim 7, wherein the settings accessible via the web portal include one or more of contact information, sensor setup, sensor configuration, gateway setup, gateway configuration, connectivity configuration, battery and power status, notification settings and information, privacy and sharing settings, and system status.

10. The remote monitoring system of claim 1, wherein the cloud computing system is further configured to send postcards and/or video messages to or from the person.

11. A method of remotely monitoring a person or animal comprising:
detecting information related to the status of one or more of the person or animal and at least one object in the person's or animal's location with at least one sensor located in the person's or animal's location;
transmitting data based on the detected information to a gateway, wherein the gateway forwards the data based on the detected information to a cloud computing system; and
receiving and processing the data based on the detected information from the gateway by a cloud computing system comprising a server, wherein the cloud computing system analyzes a plurality of abnormal activities relative to a plurality of activity patterns and initiates an action based on the received data, wherein at least one of the plurality of activity patterns further comprises an activity signal pattern of the object during a voluntary interaction of the person or animal with the object.

12. The method of claim 11, wherein the at least one sensor further comprises an accelerometer located on the object in the person's or animal's location, wherein the object further comprises at least one of a pillbox, medicine cabinet, refrigerator door, exterior door, interior door, shower door, main slipper, microwave door, oven door, trashcan lid, light switch and furniture.

13. The method of claim 11, wherein the sensor is configured to detect if the person or animal has fallen, and/or is configured to send a user-activated distress signal.

14. The method of claim 11, wherein data is transmitted between the at least one sensor and the gateway wirelessly.

15. The method of claim 11, wherein the cloud computing system comprises one or more of a datacenter, an analytics engine, and a web server.

16. The method of claim 11, wherein the action initiated by the cloud computing system is to monitor information related to the status of the person or animal or an object in the person's or animal's location detected by the at least one sensor, and to transmit a notification related to the status of the person or animal or an object in the person's or animal's location to a family member, friend, neighbor or caretaker of the person or animal, or to police, fire or emergency response personnel.

17. The method of claim 11, wherein the cloud computing system further comprises a web portal hosted on a server, and further comprising the step of providing access to the web portal to one or more users to monitor or alter settings related to one or more components of the remote monitoring system.

18. The method of claim 17, wherein the access is secured.

19. The method of claim 17, wherein the settings accessible via the web portal include one or more of contact information, sensor setup, sensor configuration, gateway setup, gateway configuration, connectivity configuration, battery and power status, notification settings and information, privacy and sharing settings, and system status.
